(19) United States
(12) Patent Application Publication
(10) Pub. No.: US 2010/0171958 A1
(43) Pub. Date: Jul. 8, 2010

(54) Localized plasmon resonance sensing device and system thereof

(75) Inventors: Lai-Kwan Chau, Chiayi City (TW); Yu-Shen Shih, Changhua County (TW); Ming-Lung Hsieh, Changhua County (TW); Chun-Chih Hou, Banciao City (TW); Chih-Chieh Chang, Taichung City (TW)

Correspondence Address: HUDAK, SHUNK & FARINE, CO., L.P.A., 2020 FRONT STREET, SUITE 307, CUYAHOGA FALLS, OH, 44221, US

(73) Assignee: NATIONAL CHUNG CHENG UNIVERSITY, CHIA-YI (TW)

(21) Appl. No.: 12/459,293

(22) Filed: Jun. 30, 2009

(30) Foreign Application Priority Data
Jan. 6, 2009 (TW) 098100149

(51) Int. Cl. G01N 21/55

(52) U.S. Cl. 356/445; 977/953

(57) ABSTRACT

The present invention discloses a LPR sensing device and a LPR sensing system comprising a LPR sensing device, a light source, a detecting unit and a processing unit. The LPR sensing device comprises a sensing substrate and a noble metal nanoparticle layer, and the noble metal nanoparticle layer is disposed on the sensing substrate and has noble metal nanoparticles with diameter of 2˜12 nm. An analyte adsorbed on the surface of the noble metal nanoparticle layer generates a dielectric environmental change, resulting in a change of the LPR band. Comparing noble metal nanoparticles with different particle diameters, small noble metal nanoparticles provide better sensing sensitivity to a compound with a small molecular weight.

### BACKGROUND OF THE INVENTION

1. Field of the Invention

The present invention relates to a sensing device and a sensing system thereof, and more particularly to a localized plasmon resonance (LPR) sensing device and a sensing system thereof.

2. Description of the Related Art

Present existing sensors adopting a localized plasmon resonance (LPR) phenomenon of noble metal nanoparticles have a detection sensitivity related to the intensity of an electric field at the surface of the nanoparticles (wherein the electric field is induced by exciting a collective oscillation of electrons at conduction bands). The closer the distance from the surface, the stronger is the intensity of the electric field. In other words, if the molecules are closer to the surface of the nanoparticles, the change of the LPR will become more significant. In general, the larger the diameter of nanoparticles, the electromagnetic-field decay length of the electric field intensity at the nanoparticle surface will be longer, meaning that the sensing depth will be greater. In view of the aforesaid description, the particle diameter of nanoparticles adopted by the present existing sensors for performing detections generally falls within a range from 12 nm to 40 nm, and these sensors may be used for detecting biochemical molecules with a higher molecular weight (such as DNA and proteins).

### SUMMARY OF THE INVENTION

In view of the aforementioned shortcomings in the prior art, the inventor of the present invention provides a LPR sensing device and a LPR system to overcome the problems of the prior art.

To achieve the foregoing objective, the present invention provides a LPR sensing device comprising a sensing substrate and a noble metal nanoparticle layer. The noble metal nanoparticle layer is disposed on the sensing substrate, and the noble metal nanoparticles have a diameter from 2 nm to 12 nm. An analyte is adsorbed on a surface of the noble metal nanoparticle layer to generate a dielectric environmental change, resulting in a change of the LPR band. Since the electric field intensity of smaller sized noble metal nanoparticles has a shorter electromagnetic-field decay length, the effect of changing the dielectric environment is greater than the nanoparticles with a greater particle diameter when a small molecule interacts with a specific modified recognition unit on the surface of a nanoparticle. Therefore the sensing sensitivity of the smaller sized noble metal nanoparticles is better than the nanoparticles with a greater particle diameter.

Another objective of the present invention is to provide a LPR sensing system comprising a LPR sensing device, a light source, a detecting unit and a processing unit. The light source provides an incident light beam into the LPR sensing device, and the detecting unit receives an emergent light from the LPR sensing device to generate a detected signal, and the processing unit is electrically connected to the detecting unit for receiving and analyzing the detected signal. The LPR sensing device comprises a sensing substrate and a noble metal nanoparticle layer. The noble metal nanoparticle layer is disposed onto the sensing substrate and the noble metal nanoparticles have a diameter from 2 nm to 12 nm. An analyte adsorbed on a surface of the noble metal nanoparticle layer generates a dielectric environmental change, resulting in a change of the LPR band. From an absorption spectrum of noble metal nanoparticles, it is observed that if an ambient refractive index rises, the absorption peak of the LPR band will shift to a longer wavelength and absorbance will rise. In addition, the observation of the characteristics of the scattered light shows that if the ambient refractive index rises, the peak of the scattered light in the spectrum will also shift to longer wavelength and the light intensity will increase.

Therefore, the LPR sensing device and the LPR sensing system of the present invention have one or more of the following advantages:

(1) The LPR sensing device and the LPR sensing system provide noble metal nanoparticle layers with a small particle diameter to overcome the shortcomings of a conventional LPR sensor that has difficulties of detecting a small molecular weight compound.

(2) For the detection of small molecular weight compounds, the LPR sensing device and the LPR sensing system have better sensing sensitivity than the nanoparticles of a greater particle diameter.

(3) The LPR sensing device and the LPR sensing system may be used for measuring the interaction between a small molecular weight compound and a specific biomolecule and understanding the specificity of bio-interaction forces, and thus they may be used in drug screening during new medicine development.

### BRIEF DESCRIPTION OF THE DRAWINGS

FIG. 1 is a schematic view of a LPR sensing device in accordance with a first preferred embodiment of the present invention;

FIG. 2A is a schematic view of a fiber-optic LPR sensing device with a certain region of an optical fiber cladding totally removed in accordance with a second preferred embodiment of the present invention;

FIG. 2B is a schematic view of a fiber-optic LPR sensing device with a certain region of an optical fiber cladding partially removed in accordance with a second preferred embodiment of the present invention;

FIG. 2C is a schematic view of a sensing probe having a mirror plated at an end of an optical fiber of a fiber-optic LPR sensing device in accordance with a second preferred embodiment of the present invention;

FIG. 2D is a schematic view of a sensing probe having noble metal nanoparticles modified at an end of an optical fiber of a fiber-optic LPR sensing device in accordance with a second preferred embodiment of the present invention;

FIG. 2E is a schematic view of a sensing probe having noble metal nanoparticles with a porous material filled into a hollow core and modified an end of an optical fiber of a fiber-optic LPR sensing device in accordance with a second preferred embodiment of the present invention;

FIG. 3 is a schematic view of a planar waveguide LPR sensing device in accordance with a third preferred embodiment of the present invention;

FIG. 4A is a schematic view of a tubular waveguide LPR sensing device in accordance with a fourth preferred embodiment of the present invention;

FIG. 4B is a schematic view of a tubular waveguide LPR sensing device having a closed end in accordance with a fourth preferred embodiment of the present invention;

FIG. 5A is a schematic view of a LPR sensing system in accordance with a fifth preferred embodiment of the present invention;

FIG. 5B is a schematic view of a spectral change graph of dodecylamine sensed by a 5 nm gold nanoparticle layer that has been modified with 11-mercaptoundecanoic acid (MUA) in a LPR sensing system in accordance with a fifth preferred embodiment of the present invention;

FIG. 5C is a schematic view of a spectral change graph of dodecylamine sensed by a 30 nm gold nanoparticle layer that has been modified with 11-mercaptoundecanoic acid (MUA) in a LPR sensing system in accordance with a fifth preferred embodiment of the present invention;

FIG. 6A is a schematic view of a LPR sensing system in accordance with a sixth preferred embodiment of the present invention;

FIG. 6B is a spectral change graph of detecting different fructose concentrations by a 5 nm gold nanoparticle layer in a LPR sensing system in accordance with a sixth preferred embodiment of the present invention;

p FIG. 6C is a graph of peak absorbance versus log[fructose concentration] by a LPR sensing system of the present invention;

FIG. 7A is a schematic view of a LPR sensing system in accordance with a seventh preferred embodiment of the present invention;

FIG. 7B is a graph of the peak absorbance of two gold nanoparticle layers with different particle diameters versus vitamin H concentration detected at a fixed wavelength of 530 nm by a LPR sensing system of the present invention;

FIG. 8A is a schematic view of a fiber-optic LPR sensing system in accordance with an eighth preferred embodiment of the present invention;

FIG. 8B is a schematic view of a linear relationship between sensor output and vitamin H concentration with a small-sized gold nanoparticle layer by a LPR sensing system in accordance with an eighth preferred embodiment of the present invention; and

FIG. 8C is a graph of sensor signal versus time of vitamin H with a concentration 10⁻⁷ M detected by gold nanoparticle layers of two different sizes by a LPR sensing system in accordance with an eighth preferred embodiment of the present invention.

### DETAILED DESCRIPTION OF THE PREFERRED EMBODIMENTS

The present invention will now be described in more detail hereinafter with reference to the accompanying drawings that show various embodiments of the invention as follows. Same numerals are used for same respective elements in the following embodiments.

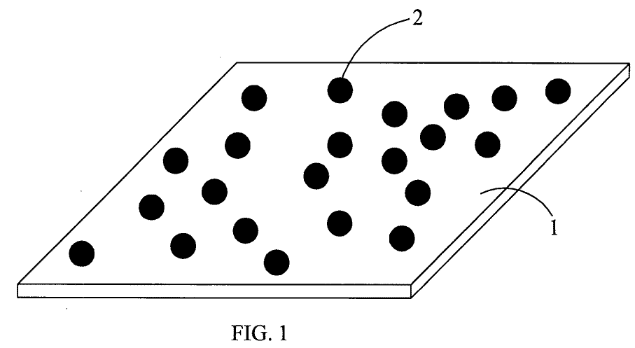

With reference to FIG. 1 for a schematic view of a LPR sensing device in accordance with a first preferred embodiment of the present invention, the LPR sensing device comprises a sensing substrate 1 and a noble metal nanoparticle layer 2. The sensing substrate 1 may be a glass slide, and the noble metal nanoparticles may be gold nanoparticles or silver nanoparticles. The noble metal nanoparticles have a diameter from 2 nm to 12 nm. An analyte adsorbed on the surface of the noble metal nanoparticle layer 2 generates a dielectric environmental change, resulting in a change of the LPR band. Any sensing device developed by disposing the small sized noble metal nanoparticle layer 2 on the sensing substrate 1 may be used together with a sensing device developed according to the principle of LPR. The sensing device is provided for sensing a compound or a biochemical molecule with a molecular weight from 1 to 5000. Exposed surfaces of these noble metal nanoparticle layers 2 may achieve a highly specific sensing capability by means of modifying a specific recognition unit on the nanoparticle surface. In FIG. 1, the gold nanoparticles are disposed on a dry clean glass slide, and an optical sensing device is provided for measuring an incident light and a transmitted light, a reflected light or a scattered light. The relative relation about a change of resonance peak intensity or a shift of resonance wavelength and an analyte concentration are analyzed to establish the sensing system.

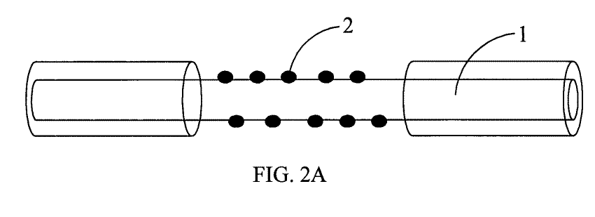

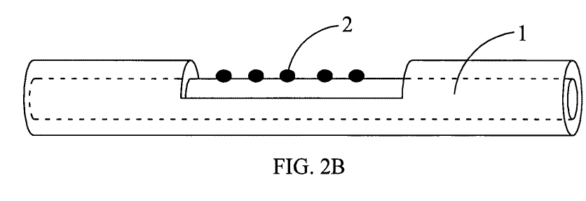

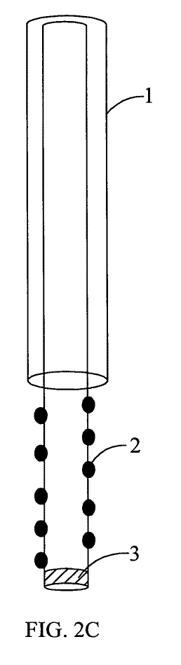

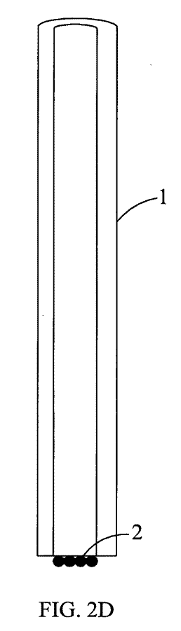

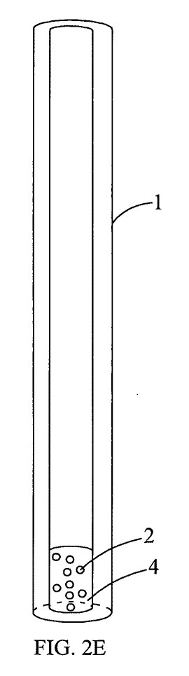

With reference to FIG. 2 for a schematic view of a LPR sensing device in accordance with a second preferred embodiment of the present invention, the LPR sensing device comprises a sensing substrate 1 and a noble metal nanoparticle layer 2. The sensing substrate 1 may be an optical fiber, and the noble metal nanoparticles may be gold nanoparticles or silver nanoparticles. The noble metal nanoparticles have a diameter from 2 nm to 12 nm. An analyte adsorbed on the surface of the noble metal nanoparticle layer 2 generates a dielectric environmental change, resulting in a change of the LPR band. The optical fiber is selected to form a fiber-optic localized plasmon resonance (FO-LPR) device, and the evanescent wave phenomenon and multiple internal reflections occurred at the reflecting interface is used to enhance the change of LPR response. Since the intensity of evanescent waves is affected by the change of the LPR band, the difference of signals in the absence and in the present of an analyte may be obtained. The optical fiber may be one with the cladding at a certain region removed totally (as shown in FIG. 2A), or removed partially (as shown in FIG. 2B), and the noble metal nanoparticle layer 2 used for the detection may be used together with small sized noble metal nanoparticles to develop highly sensitive fiber-optic sensors suitable for small molecules and rapid screening. In a reflection-based fiber-optic LPR sensing device as shown in FIG. 2C, a mirror 3 is plated at a rear end of the optical fiber to reflect light signals, such that the structure is like a probe capable of sensing when the structure is dipped in a liquid sample or pierced into a biological object. Such a structure is suitable to be developed as an equipment for both in vivo sensing and medical treatment, and the resulting sensing device with small sized noble metal nanoparticles is suitable for detecting small molecules. In FIG. 2D, a sensing probe has a small sized noble metal nanoparticle layer 2 plated onto one end of an optical fiber I of the sensing device, and the intensity of a scattered light or a reflected light is used for the detection. Since the cladding of the optical fiber of this structure is not removed, the optical fiber has better mechanical strength. In FIG. 2E, the sensing device has an etched hollow core at one end of an optical fiber, and then a porous material 4 (such as sol-gel) is filled into the hollow space. Finally the small sized noble metal nanoparticles are disposed onto the surface of the porous material 4 to complete the construction of the probe. With the advantages of the porous material with many holes and a large surface area, both the mass transfer rate and the quantity of an analyte adsorbed at the surface of small sized noble metal nanoparticles may be increased.

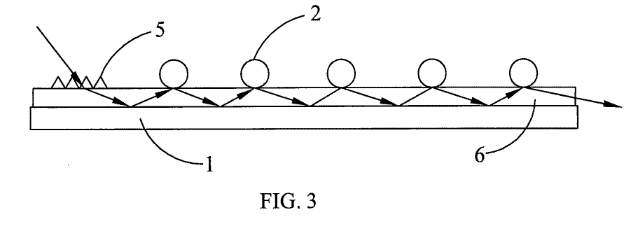

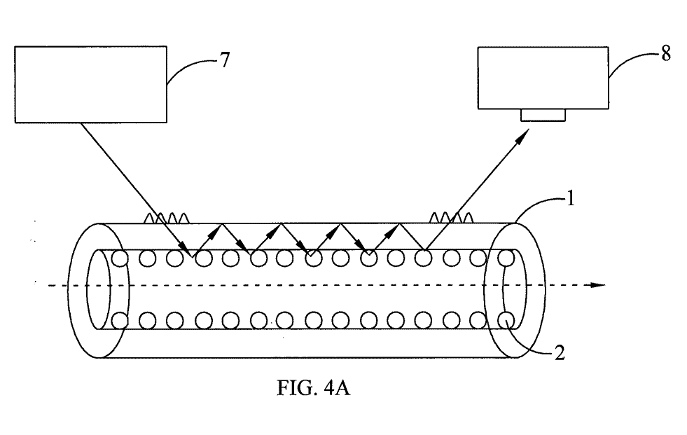

With reference to FIG. 3 for a schematic view of a LPR sensing device in accordance with a third preferred embodiment of the present invention, the LPR sensing device comprises a sensing substrate 1 and a noble metal nanoparticle layer 2. The sensing substrate 1 may be a planar waveguide, and the noble metal nanoparticles may be gold nanoparticles or silver nanoparticles, and the noble metal nanoparticles have a diameter from 2 nm to 12 nm. An analyte adsorbed on the surface of the noble metal nanoparticle layer 2 generates a dielectric environmental change, resulting in a change of the LPR band. With a prism or a grating 5, a light beam is guided into a thin film with a light transmission capability. During the transmission process, the transmitted light will be absorbed and the light intensity will be decreased due to the characteristics of the LPR of the noble metal nanoparticles. With a waveguide 6, the light in the thin film may be transmitted through multiple total internal reflections, such that the signal change may be enhanced effectively by measuring the intensity of the emergent light. The difference between the intensities of an emergent light in the absence and in the presence of an analyte may be used to quantify the amount of analyte. Because of the small size of the optical sensing device, an array of sensing devices may be constructed. This structure used together with the small sized noble metal nanoparticle layer 2 not only has the capability of analyzing a small molecular compound of a very low concentration, but may also be used for screening of small molecular medicines.

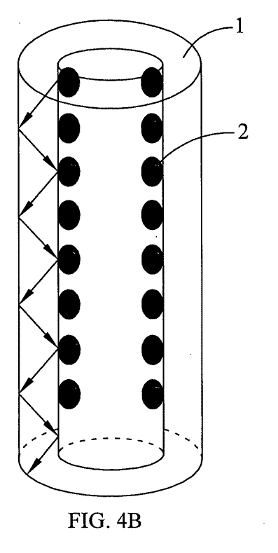

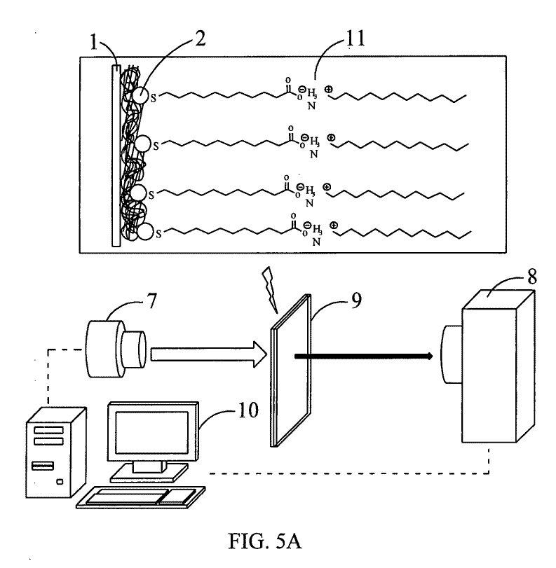

With reference to FIG. 4 for a schematic view of a LPR sensing device in accordance with a fourth preferred embodiment of the present invention, the LPR sensing device comprises a sensing substrate 1 and a noble metal nanoparticle layer 2. The sensing substrate 1 may be a tubular waveguide, and the noble metal nanoparticles may be gold nanoparticles or silver nanoparticles, and the noble metal nanoparticles have a diameter from 2 nm to 12 nm. An analyte adsorbed on the surface of the noble metal nanoparticle layer 2 generates a dielectric environmental change, resulting in a change of the LPR band. The main concept of the tubular waveguide LPR sensing device resides on the principle of producing a multiple of total internal reflections by the optical waveguide technology and the evanescent wave phenomenon occurred at the reflecting interface to enhance the change of LPR response, so that a change of intensity of an emergent light exiting the waveguide provides information related to the concentration of the analyte (as shown in FIG. 4A). Using the tubular waveguide, the structure has the advantages of a small volume and a good structural shape. The sealed tubular waveguide LPR sensing device may serve as a container for containing a sample (as shown in FIG. 4B), and thus they may further be arranged in an array form. With appropriate light source 7 and detecting unit 8, a highly sensitive sensing array for high-throughput screening may be developed.

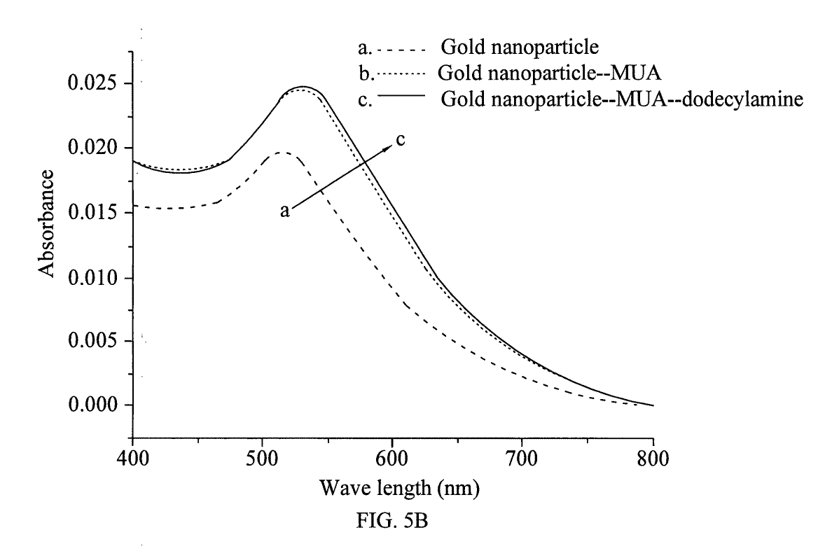

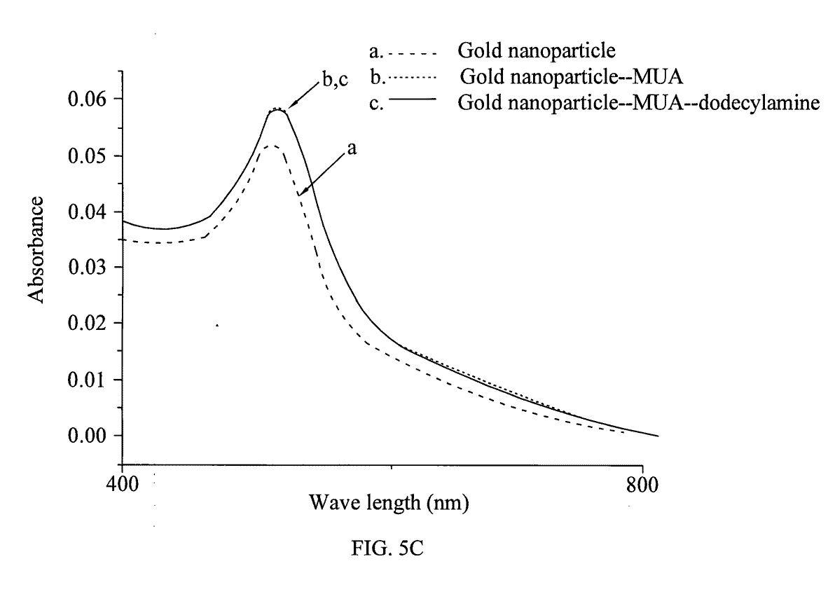

With reference to FIG. 5 for a schematic view of a LPR sensing device in accordance with a fifth preferred embodiment of the present invention, the LPR sensing device comprises a LPR sensing device 9, a light source 7, a detecting unit 8 and a processing unit 10. The light source 7 may be a laser or a light emitting diode, and the detecting unit 8 may be a light intensity detector. The processing unit 10 may be a computer, and the light source 7 is provided for projecting a light beam onto the LPR sensing device 9. The detecting unit 8 is provided for receiving the emergent light from the LPR sensing device 9 to generate a detected signal, and the processing unit 10 is electrically connected to the detecting unit 8 for receiving and analyzing the detected signal. The LPR sensing device 9 comprises a sensing substrate 1 and a noble metal nanoparticle layer 2. The sensing substrate 1 may be a glass slide, and the noble metal nanoparticles may be gold nanoparticles. The gold nanoparticles are disposed onto the glass slide, and the noble metal nanoparticles have a diameter from 2 nm to 12 nm. An analyte adsorbed on the surface of the noble metal nanoparticle layer 2 generates a dielectric environmental change, resulting in a change of the LPR band. In this preferred embodiment, an experiment is designed for showing that small sized gold sphere nanoparticles have a better sensitivity for detecting compounds with a small molecular weight than other spherical nanoparticles with a larger particle diameter. Firstly, positively charged polyallylamine hydrochloride (PAH) is used as a linker for disposing spherical gold nanoparticles having a particle diameter of 5 nm onto a glass slide, and then the gold nanoparticles-modified glass slide is dipped into a solution of 11-mercaptoundecanoic acid (MUA), by which the —SH group is chemisorbed on the nanoparticle surface and has carboxyl (—COOH) group exposed on the surface. From the absorption spectra, it is found that there are a slight red shift of the LPR band and a rise of absorbance as shown in FIG. 5B, indicating that a self-assembled monolayer of MUA is formed on the surface of the gold nanoparticles to constitute a basic sensing system (FIG. 5A). In practical implementations, an appropriate pH value (pH˜7) is controlled, such that the —COOH functional group carried by MUA molecules on the surfaces of the gold sphere nanoparticles are ionized into an ionic state (—COO⁻). Therefore, an attractive force between the negative charged nanoparticle surface and the analyte 11 (dodecylamine, MW=185) that carries positively charged —NH₃⁺ group lead to the formation of a surface complex, and the change of absorption spectra of gold nanoparticles measured before and after immersion in the sample may be used for determining whether or not dodecylamine is attached onto the surface of the gold nanoparticle layer. To verify that small-sized gold nanoparticles have better sensing capability for small molecules, we also use the gold nanoparticles with a particle diameter approximately equal to 24 nm for the experiment performed at the same concentration (10⁻⁶ M) of the analyte, but the absorption spectrum does not show any significant change (as shown in FIG. 5C). As a consequence, we may make a deductive inference that small sized gold nanoparticles have better sensing capability than larger gold nanoparticles for detecting small molecules.

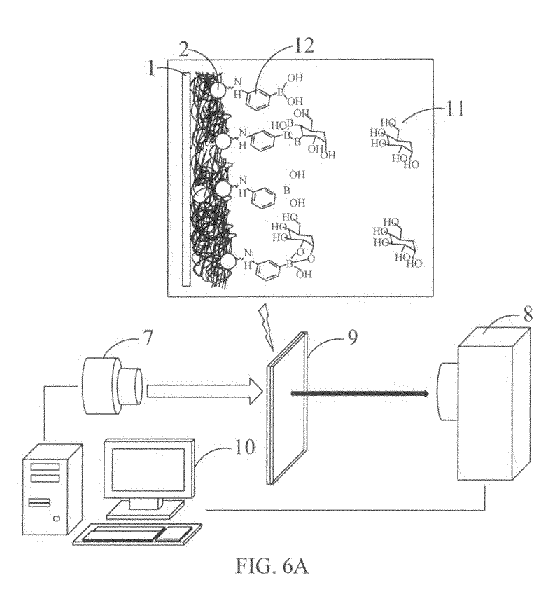

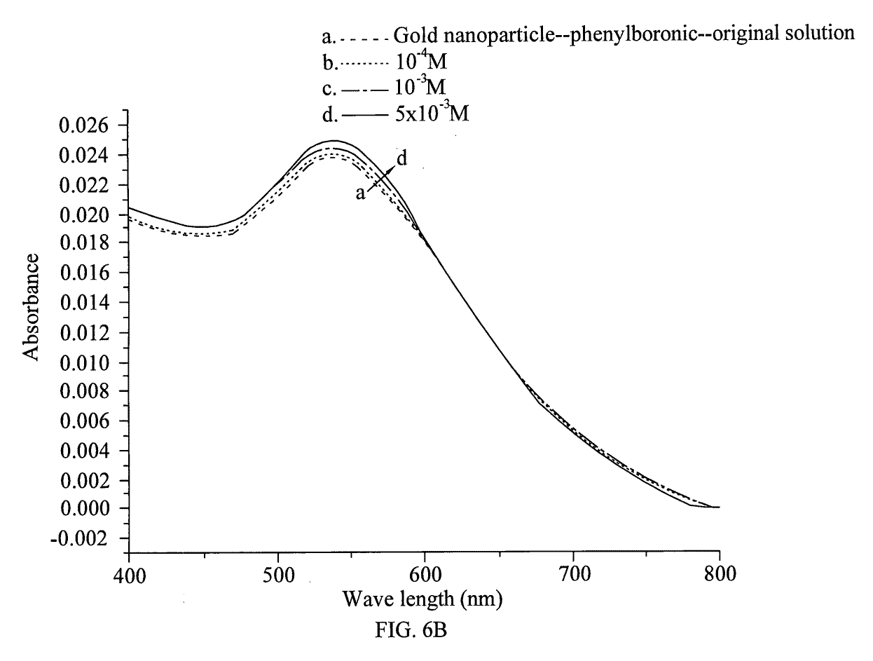

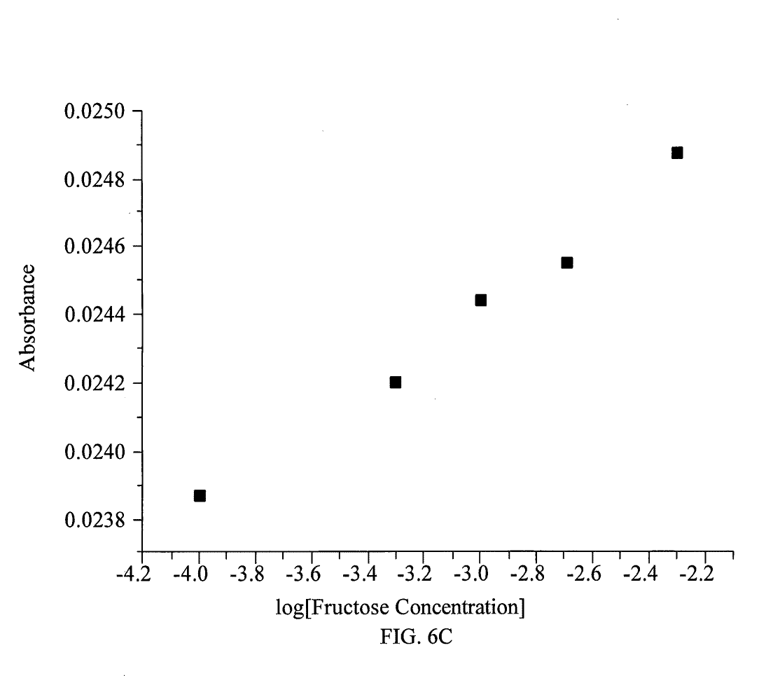

With reference to FIG. 6 for a schematic view of a LPR sensing system in accordance with a sixth preferred embodiment of the present invention, the LPR sensing system comprises a LPR sensing device 9, a light source 7, a detecting unit 8 and a processing unit 10. The light source 7 may be a laser or a light emitting diode, and the detecting unit 8 may be a light intensity detector. The processing unit 10 may be a computer, and the light source 7 is provided for projecting a light beam onto the LPR sensing device 9. The detecting unit 8 is provided for receiving an emergent light from the LPR sensing device 9 to generate a detected signal, and the processing unit 10 is electrically connected to the detecting unit 8 for receiving and analyzing the detected signal. The LPR sensing device 9 comprises a sensing substrate 1 and a noble metal nanoparticle layer 2. The sensing substrate 1 may be a glass slide, and the noble metal nanoparticles may be gold nanoparticles. The gold nanoparticles are disposed onto a glass slide, and the noble metal nanoparticles have a diameter from 2 nm to 12 nm. An analyte adsorbed on the surface of the noble metal nanoparticle layer 2 generates a dielectric environmental change, resulting in a change of the LPR band. In this embodiment, spherical gold nanoparticles with a particle diameter approximately equal to 5 nm is used to verify whether or not small sized gold nanoparticles have better sensitivity for sensing small molecules. Similarly, we first use the polymer PAH as a linker to dispose the gold nanoparticles onto the glass slide, and then use 3-mercaptopropionic acid (MPA) to form a self-assembled monolayer with the —COOH functional group on the surface, and then go through an activation by N-(3-dimethylaminopropyl)-N-ethylcarbodiimide hydrochloride (EDC.HCl)/N-hydroxysuccinimide (NHS) to form a covalent —NHCO— bond with 3-aminophenylboronic acid, so as to complete the sensing system as shown in FIG. 6A. Wherein, the noble metal nanoparticles were modified with a recognition unit 12 for sensing an analyte 11, and the recognition unit 12 may be 3-aminophenylboronic acid molecules and used for sensing saccharide molecules. The recognition molecule will form bonds with the diol group on the saccharide molecule to form a pentacyclic or hexacyclic structure. In this preferred embodiment, we use phenylboronic acid molecules as recognition molecules for sensing small saccharide molecules. In an experiment with fructose (MW=180) concentration increased from 0.1 mM to 5 mM, an increase in peak absorbance in the LPR band was observed. With reference to FIG. 6B for a spectral change graph of detecting different fructose concentrations with 5 nm gold nanoparticles by a LPR sensing system in accordance with a sixth preferred embodiment of the present invention, the spectra show that the 5 nm gold nanoparticles have good sensing sensitivity for fructose. With reference to FIG. 6C for a graph of peak absorbance versus log[fructose concentration] by a LPR sensing system of the present invention, the data show that of the peak absorbance of the LPR band varies linearly with the log[fructose concentration].

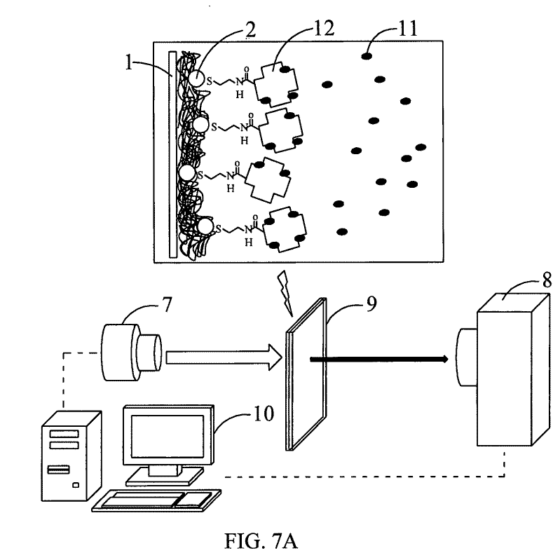

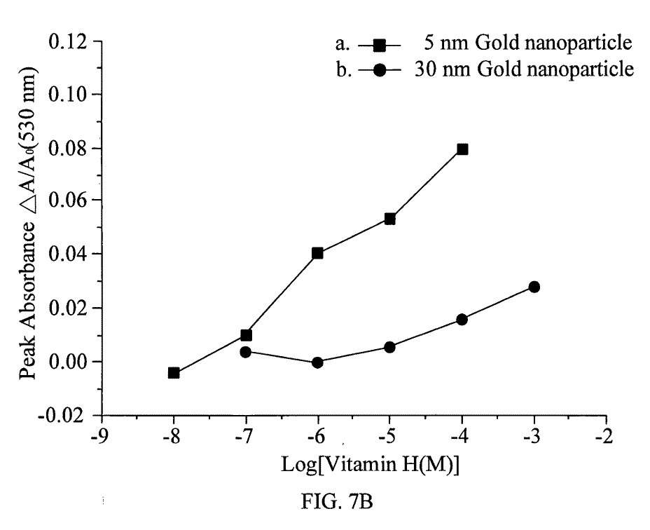

With reference to FIG. 7 for a schematic view of a LPR sensing system in accordance with a seventh preferred embodiment of the present invention, the LPR sensing system comprises a LPR sensing device 9, a light source 7, a detecting unit 8 and a processing unit 10. The light source 7 may be a laser or a light emitting diode, and the detecting unit 8 may be a light intensity detector. The processing unit 10 may be a computer, and the light source 7 is provided for projecting a light beam onto the LPR sensing device 9. The detecting unit 8 is provided for receiving an emergent light from the LPR sensing device 9 to generate a detected signal, and the processing unit 10 is electrically connected to the detecting unit 8 for receiving and analyzing the detected signal. The LPR sensing device 9 comprises a sensing substrate 1 and a noble metal nanoparticle layer 2. The sensing substrate 1 may be a glass slide, and the noble metal nanoparticles may be gold nanoparticles. The gold nanoparticles are disposed onto a glass slide, and the noble metal nanoparticles have a diameter from 2 nm to 12 nm. An analyte adsorbed on the surface of the noble metal nanoparticle layer 2 generates a dielectric environmental change, resulting in a change of the LPR band. In this preferred embodiment, we use spherical gold nanoparticles with particle diameters equal to 5 nm and 30 nm respectively to verify whether or not small sized gold nanoparticles have better sensing sensitivity for small molecules. Similarly, we first use the polymer PAH as a linker to dispose the gold nanoparticles onto the glass slide, and then use 3-mercaptopropionic acid (MPA) to form a self-assembled monolayer with the —COOH functional group on the surface, and then go through an activation by EDC.HCl/NHS to form a covalent —NHCO— bond with streptavidin, so as to complete the sensing system as shown in FIG. 7A. Wherein, the noble metal nanoparticles were modified with a recognition unit 12 (streptavidin) for detecting an analyte 11 (vitamin H), since streptavidin and vitamin H form strong bonds (Kd˜10⁻¹⁵ M). In the experiment of using gold nanoparticles with a particle diameter approximately equal to 5 nm as a sensor for detecting vitamin H (MW=244), the spectra show that there is an increasing change of sensor response. When a wavelength (530 nm) within the LPR band is selected, we may observe a change of absorbance □A (□A=A₁−A₀); where A₁ is the absorbance with vitamin H at different concentrations, and A₀ which is the absorbance before vitamin H is added. When the concentration of vitamin H is greater than 10⁻⁷ M, FIG. 7B shows that the change of relative absorbance (□A/A₀) increases at higher vitamin H concentration. If the sensing system is substituted by the 30 nm gold nanoparticles for the detection, the concentration of vitamin H must reach 10⁻⁵ M before there is a slight change of the relative absorbance. Compared with the result illustrated in FIG. 7B, we may find out that the 5 nm gold nanoparticles have a sensing sensitivity approximately equal to 2.4 times better than the 30 nm gold nanoparticles for detecting vitamin H (For the absorbance change of vitamin H per each unit of concentration, the linear slope ratio m₅ₙₘ/m₃₀ₙₘ=0.022/0.009).

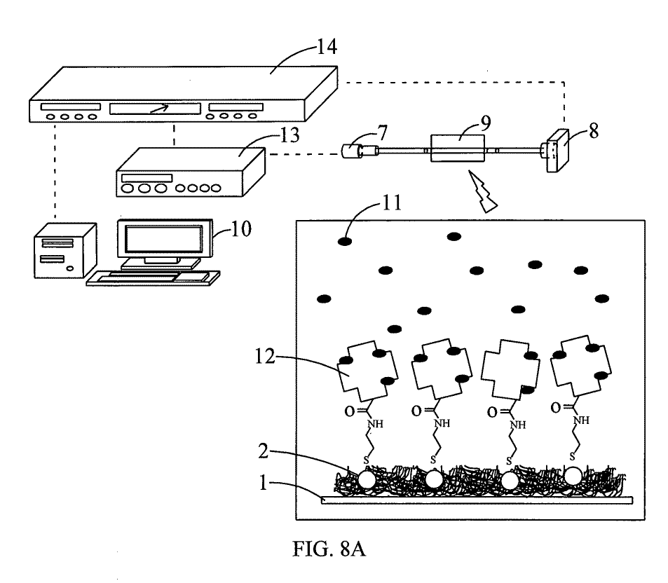

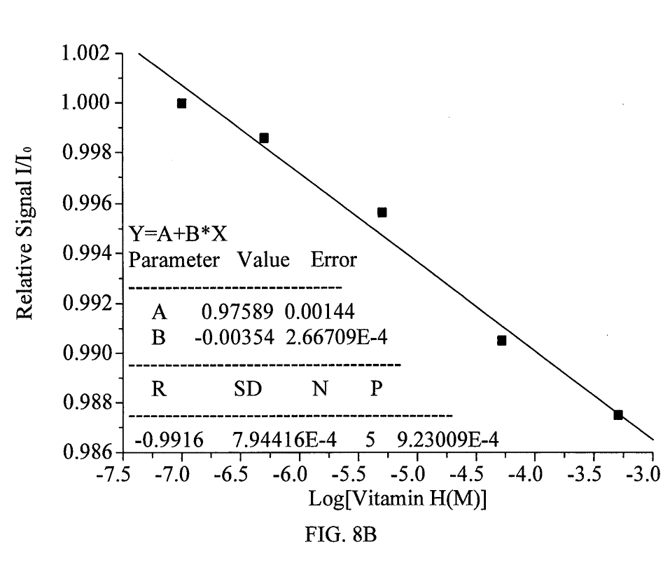

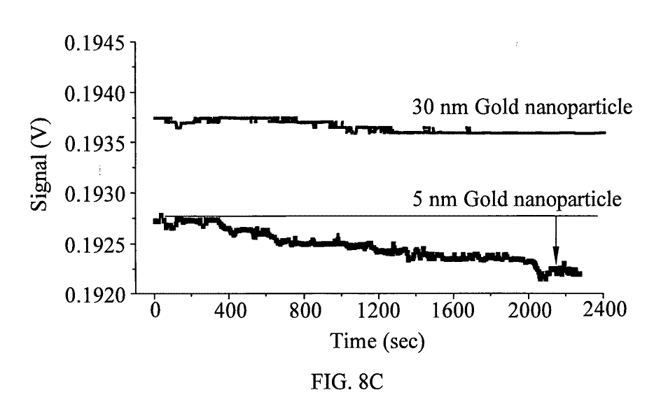

With reference to FIG. 8 of a schematic view of a fiber-optic LPR sensing system in accordance with an eighth preferred embodiment of the present invention, the LPR sensing system comprises a LPR sensing device 9, a light source 7, a detecting unit 8 and a processing unit 10. The light source 7 may be a laser or a light emitting diode, and the detecting unit 8 may be a light intensity detector. The processing unit 10 may be a computer, and the light source 7 projects a light beam onto the LPR sensing device 9. The detecting unit 8 is provided for receiving an emergent light from the LPR sensing device 9 to generate a detected signal, and the processing unit 10 is electrically connected to the detecting unit 8 for receiving and analyzing the detected signal. The system further comprises a function generator 13 and a lock-in amplifier 14, and the LPR sensing device 9 comprises a sensing substrate 1 and a noble metal nanoparticle layer 2. The sensing substrate 1 may be an optical fiber, and the noble metal nanoparticles may be gold nanoparticles. The gold nanoparticles are disposed onto the optical fiber, and the noble metal nanoparticles have a diameter from 2 nm to 12 nm. An analyte adsorbed on the surface of the noble metal nanoparticle layer 2 generates a dielectric environmental change, resulting in a change of the LPR band. In this preferred embodiment, we use spherical gold nanoparticles with particle diameters equal to 5 nm and 30 nm respectively to verify whether or not small sized gold nanoparticles have better sensing sensitivity for small molecules. Similarly, we first use the polymer PAH as a linker to dispose the gold nanoparticles onto the optical fiber, and then use cystamine to form a self-assembled monolayer with the —NH₂ functional group on the surface, and then go through the activation by EDC.HCl/NHS to form covalent —NHCO— bond with streptavidin, so as to complete the optical fiber sensing system as shown in FIG. 8A. With reference to FIG. 8B for a schematic view of a linear relationship between sensor response and vitamin H concentration detected by a LPR sensing system with small-sized gold nanoparticles in accordance with an eighth preferred embodiment of the present invention, vitamin H with a concentration between 1×10⁻⁷-5×10⁻⁴ M is used to demonstrate the sensing capability of gold nanoparticles with a particle diameter of approximately 5 nm in the optical fiber system where the gold nanoparticle surface is modified with a recognition unit 12 (streptavidin) for detecting an analyte 11 (vitamin H). With reference to FIG. 8C for a graph of signal versus time with vitamin H at a concentration of 10⁻⁷ M detected by gold nanoparticles of different sizes in an optical fiber sensing system in accordance with an eighth preferred embodiment of the present invention, there is no significant change in signal with gold nanoparticles of about 30 nm diameter while a change of signal is observed with gold nanoparticles of about 5 nm diameter. Thus we may confirm our deductive inference that small sized gold nanoparticles have better sensing capability than larger gold nanoparticles for detecting small molecules and vitamin H in this case.

While the invention has been described by means of specific embodiments, numerous modifications and variations could be made thereto by those skilled in the art without departing from the scope and spirit of the invention set forth in the claims.

What is claimed is:

1. A localized plasmon resonance (LPR) sensing device, comprising:
a sensing substrate; and
a noble metal nanoparticle layer, disposed onto the sensing substrate, and having noble metal nanoparticles with a diameter from 2 nm to 12 nm;
wherein an analyte adsorbed on a surface of the noble metal nanoparticle layer generates a dielectric environmental change, resulting in a change of a LPR band.

2. The LPR sensing device of claim 1, wherein the sensing substrate is a glass slide, an optical fiber or a waveguide.

3. The LPR sensing device of claim 2, wherein the waveguide is a planar waveguide or a tubular waveguide.

4. The LPR sensing device of claim 1, wherein the noble metal nanoparticle layer is made of gold nanoparticles or silver nanoparticles.

5. The LPR sensing device of claim 1, wherein the noble metal nanoparticle layer is provided for detecting a compound or a biochemical molecule.

6. The LPR sensing device of claim 5, wherein the compound or the biochemical molecule has a molecular weight ranging from 1 to 5000.

7. The LPR sensing device of claim 1, wherein the noble metal nanoparticle layer is provided for modifying a recognition unit.

8. A localized plasmon resonance (LPR) sensing system, comprising:
a LPR sensing device, comprising:
a sensing substrate; and
a noble metal nanoparticle layer disposed onto the sensing substrate and having noble metal nanoparticles with a diameter from 2 nm to 12 nm;
a light source providing a light beam to project onto the LPR sensing device;
a detecting unit receiving an emergent light from the LPR sensing device to generate a detected signal; and
a processing unit electrically coupled to the detecting unit for receiving and analyzing the detected signal;
wherein an analyte adsorbed on a surface of the noble metal nanoparticle layer generates a dielectric environmental change, resulting in a change of a LPR band.

9. The LPR sensing system of claim 8, wherein the sensing substrate is a glass slide, an optical fiber or a waveguide.

10. The LPR sensing system of claim 9, wherein the waveguide is a planar waveguide or a tubular waveguide.

11. The LPR sensing system of claim 8, wherein the noble metal nanoparticle layer is made of gold nanoparticles or silver nanoparticles.

12. The LPR sensing system of claim 8, wherein the metal nanoparticle layer is provided for detecting a compound or a biochemical molecule.

13. The LPR sensing system of claim 12, wherein the compound or the biochemical molecule has a molecular weight ranging from 1 to 5000.

14. The LPR sensing system of claim 8, wherein the noble metal nanoparticle layer is provided for modifying a recognition unit.

15. The LPR sensing system of claim 8, wherein the light source is a laser or a light emitting diode (LED).

16. The LPR sensing system of claim 8, wherein the detecting unit is a light intensity detector.

17. The LPR sensing system of claim 8, wherein the processing unit is a computer.

18. The LPR sensing system of claim 8, further comprising a function generator and a lock-in amplifier.
